(19) United States
(12) Patent Application Publication
(10) Pub. No.: US 2004/0156276 A1
(43) Pub. Date: Aug. 12, 2004

(54) Method of selecting laser beam in an optical disk drive

(76) Inventor: Chi-Hsiang Kuo, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/624,775

(22) Filed: Jul. 21, 2003

(30) Foreign Application Priority Data
Feb. 12, 2003 (TW) 092102922

(51) Int. Cl. G11B 7/095

(52) U.S. Cl. 369/44.26; 369/44.37; 369/53.23

(57) ABSTRACT

A method of selecting laser beam in an optical disk drive is disclosed. A first laser beam (such as CD laser beam) is used to read an optical disk and generate a first testing result. Whether the first testing result is normal is then determined. The first laser beam is used to read data from the optical disk if the first testing result is normal, and a second laser beam (such as DVD laser beam) is, in stead, used to read data from the optical disk if the first testing result is abnormal.

This application claims the benefit of Taiwan application Serial No. 92102922, filed Feb. 12, 2003.

### BACKGROUND OF THE INVENTION

1. Field of the Invention

The invention relates in general to a method of reading an optical disk in an optical disk drive, and more particularly to a method of selecting laser beam for reading an optical disk in an optical disk drive.

2. Description of the Related Art

In the era of technology with rapid advances, as a result of the popularity of data with large memory capacity, like pictures, music, movies, and computer software, optical disk has become indispensable for every computer user. Two main categories of the optical disk are compact disc (CD) and digital versatile disc (DVD). With the advantages of large memory capacity, small size, and safety in storing data, the optical disk distinguishes itself in all kinds of storages. Furthermore, an optical disk drive capable of reading CD and DVD becomes one of the essential equipments of a personal computer.

Referring to FIG. 1, a flow chart of the conventional method of reading a CD in an optical disk drive is shown. First, in the step 102, a CD, put into an optical disk drive, is driven to revolve. Next, in the step 104, an optical pickup head of the optical disk drive is moved to one side of the revolving CD. Afterwards, in the step 106, CD laser beam of the optical pickup head is used to read the CD, and a focus servo system of the optical disk drive is fine adjusted to focus the laser beam. CD laser beam is deviated into three beams: a main beam and two sub-beams. The two sub-beams symmetrically locate at two sides of the main beam. The main beam and the two sub-beams illuminate the CD to correspondingly form a main spot and two sub spots.

Subsequently, in the step 108, a tracking servo system of the optical disk drive is fine adjusted and a tracking error signal is generated to conduct a tracking process. The tracking error signal indicates whether the main spot is correctly located on the CD track. The continuing or terminating of the tracking process depends on the tracking error signal. Going to the step 110, while the main spot positions on the CD track, the tracking error signal is correct and the CD laser beam is used to read data from the CD.

The track pitch of the optical disk is related to the spot size. The spot size is in direct proportion to the wavelength of the laser beam. According to the standard scales, the CD track pitch is 1.6 μm, and the wavelength of the CD laser beam is 780 nm. Therefore, light spots will fall on the CD track if the spot size formed by the CD laser beam as illuminating CD is about 1.7 to 1.9 μm. The standard scale of the DVD track pitch is 0.74 μm and the wavelength of the DVD laser beam is 650 nm. Therefore, light spots will fall on the DVD track if the spot size formed by the DVD laser beam as illuminating DVD is about 1.0 to 1.2 μm. In addition, since the spot size of the DVD is smaller than that of the CD, and CD track pitch is larger than DVD track pitch, DVD laser beam can be used to read data from a CD, but CD laser beam cannot be used to read data from a DVD.

However, some industrials design a CD track size between CD track pitch and DVD track pitch in order to increase the CD memory capacity. This sore of CD having larger memory capacity than a standard one (for example 720 MB) may cause the failure of precisely falling on the CD track for the main spot of the CD laser beam. Therefore, the tracking error signal shows incorrect and the CD laser beam cannot read data from this sore of CD. Limitation of applicable optical disks and reduced ration of reading optical disk in an optical disk drive are the additional consequential drawbacks. Due to uneven quality of CDs in the market, an optical disk drive, which uses only CD laser beam to read CDs, is apparent unsatisfied.

### SUMMARY OF THE INVENTION

It is therefore an object of the invention to provide a method of selecting laser beam in an optical disk drive. By the design of incorporating CD laser beam with DVD laser beam, the efficiency of the optical disk drive can be improved in reading an optical disk having a track size between the CD track pitch and the DVD track pitch, and the disc-picking issue can be also solved as generated in a conventional optical disk drive.

The invention achieves the above-identified object by providing a method of selecting laser beam in an optical disk drive by which CD laser beam or DVD laser beam is selected to read data from an optical disk. According to the method, first, CD laser beam is used to read an optical disk to generate a first tracking error signal. Subsequently, it is determined if the first tracking error signal is correct. If the first tracking error signal is correct, CD laser beam is used to read data from the optical disk. If the first tracking error signal is incorrect, DVD laser beam is, in stead, used to read the optical disk and generate a second tracking error signal. It is determined if the second tracking error signal is correct. If the second tracking error signal is correct, the DVD laser beam is used to read data from the optical disk. If the second tracking error signal is incorrect, the approach is ended.

The invention achieves the above-identified object by further providing a method of selecting laser beam in an optical disk drive, by which CD laser beam or DVD laser beam is selected to read data from an optical disk. According to the method, first, CD laser beam is used to read memory capacity of the optical disk. Subsequently, it is determined if the memory capacity is not lager than a standard memory capacity. If the memory capacity is not larger than the standard one, the CD laser beam is used to read data from the optical disk. If the memory capacity is larger than the standard one, DVD laser beam is, in stead, used to read the optical disk and generate a tracking error signal. It is determined if the tracking error signal is correct. If the tracking error signal is correct, the DVD laser beam is used to read data from the optical disk. If the tracking error signal is incorrect, the approach is ended.

The invention achieves the above-identified object by providing another method of selecting laser beam in an optical disk drive, by which a first laser beam or a second laser beam is selected to read data from an optical disk. The wavelength of the second laser beam can be either larger or smaller than that of the first laser beam. According to the method, first, the first laser beam is used to read the optical disk and generate a first testing result. Subsequently, it is determined if the first testing result is normal. If the first testing result is normal, the first laser beam is used to read data from the optical disk. If the first testing result is unusual, the second laser beam is, in stead, used to read data from the optical disk. The first laser beam can be CD laser beam of wavelength 780 nm while the second one is DVD laser beam of wavelength 650 nm or the first laser beam can be DVD laser beam of wavelength 650 nm while the second one is CD laser beam of wavelength 780 nm.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a flow chart of the method of reading data from a CD in a conventional optical disk drive; and

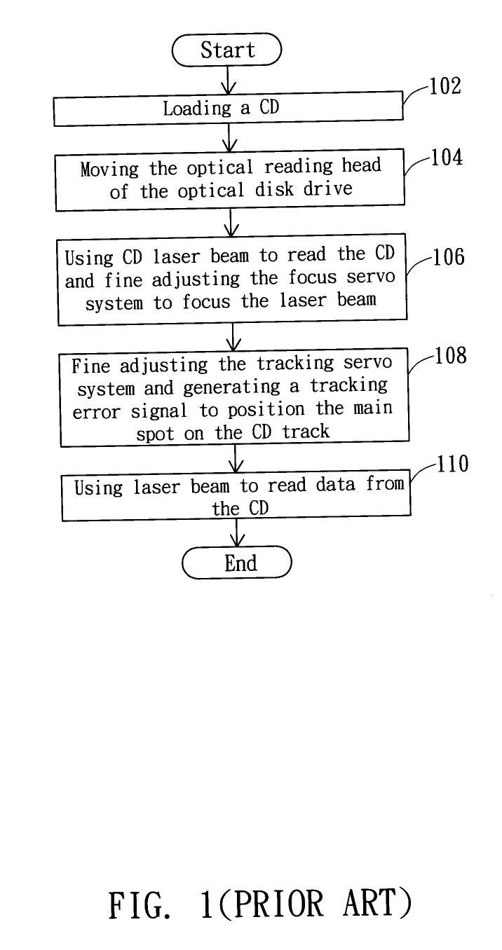

FIG. 2 is a flow chart of the method of selecting laser beam to read a CD and a DVD in an optical disk drive according to a preferred embodiment in the invention.

### DETAILED DESCRIPTION OF THE INVENTION

A method of selecting laser beam in an optical disk drive is designed in the invention. In the optical disk drive, DVD laser beam is selected to read data from an optical disk having a track size between the CD track pitch (1.6 μm) and the DVD track pitch (0.74 μm) in order to improve the efficiency of the optical disk drive in reading optical disks.

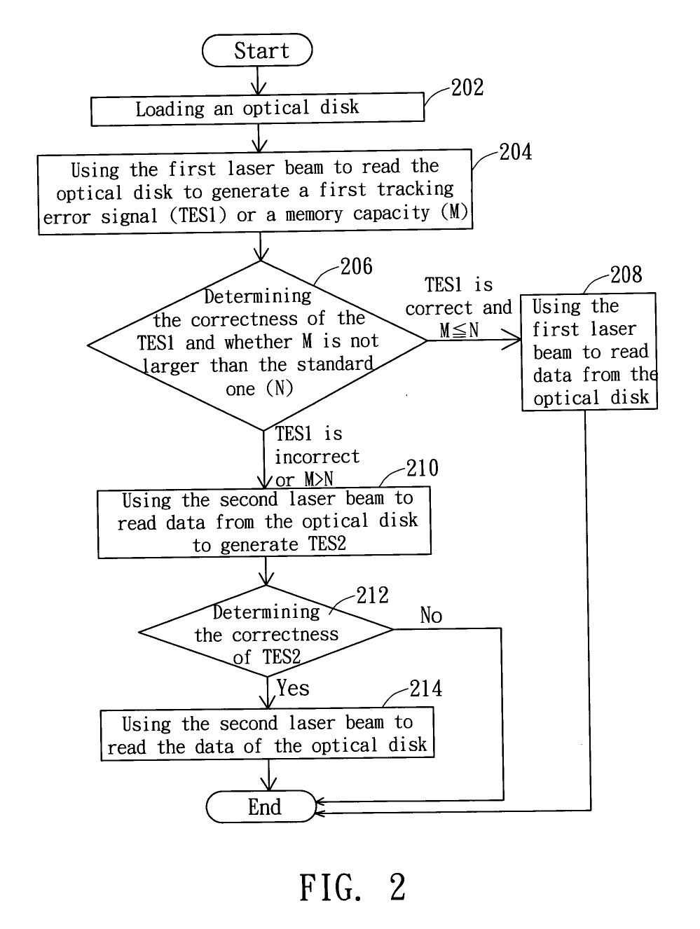

Referring to FIG. 2, a flow chart of the method of selecting laser beam to read a CD and a DVD in an optical disk drive according to a preferred embodiment in the invention is shown. In FIG. 2, first, in the step 202, an optical disk, put into the optical disk drive, is driven to revolve. The optical disk drive can be an optical disk drive capable of reading CD and DVD optical disks, the optical pickup head of the optical disk drive can irradiate CD laser beam and DVD laser beam. The wavelength of the CD laser beam is 780 nm and that of the DVD laser beam is 650 nm for example. Afterwards, in the step 204, the first laser beam is used to read the optical disk and generate a first testing result. The first testing result can be either a first tracking error signal (TES1) or a memory capacity (M) of the optical disk. The first laser beam can be CD laser beam or DVD laser beam.

Subsequently, the step 206 is conducted, which includes determining the correctness of the TES1 and comparing the value of M with the value of the standard one (N). If the first testing result is normal, for example, the first tracking error signal (TES1) is correct and the memory capacity (M) of the optical disk is not larger than the standard one (N), the step 208 is executed. In this condition, the first laser beam is used to read data from the optical disk. Then, the procedure of selecting laser beam and data reading is completed. However, if the determining step 206 shows the first testing result is abnormal, including the incorrectness of the first tracking error signal (TES1), or the fact that the memory capacity (M) is larger than the standard one (N), the step 210 is conducted. The standard memory capacity of a typical CD is about 720 MB.

In the step 206, to determine the normality of the first test result can be completed by setting a threshold of the TES1. The first testing result is set as normal while the TES1 is not small than the threshold. Therefore, the step 208 is performed while the first tracking error signal (TES1) is not smaller than a threshold, and also the memory capacity (M) is not larger than a standard one (N). Otherwise, the step 210 is conducted. In other words, the step 210 in executed in the condition that the first tracking error signal (TES1) is smaller than a threshold, or the memory capacity (M) is larger than a standard one (N).

In the step 210, the second laser beam is used to read data from the optical disk to generate a second testing result, for example, a second tracking error signal (TES2). The wavelength of the second laser beam can be either larger or smaller than that of the first one. While CD laser beam is chosen as the first laser beam, the second one is DVD laser beam. On the other hand, while DVD laser beam is selected as the first laser beam, the second one is CD laser beam. After the step 210, the step 212 of determining the correctness of TES2 is performed. If the second testing result is normal, that is, the second tracking error signal (TES2) is correct, the step 214 is executed. The second laser beam is used to read data from the optical disk, and then the procedure of beam selection and data reading is completed. However, if the second testing result is unusual, for example, if the second tracking error signal (TES2) is incorrect, the procedure is terminated directly.

The standard scale of the DVD track pitch is 0.74 μm and the wavelength of the DVD laser beam is 650 nm. The standard scales of the CD track pitch is 1.6 μm and the wavelength of the CD laser beam is 780 nm. The conventional device and method doesn't provide alternative laser beam source. However, according to the invention, the DVD laser beam can be alternatively used to read the optical disk when the optical disk cannot be read by CD laser beam. In this way, the efficiency of the optical disk drive in reading optical disks is improved. Therefore, as the concept of DVD laser beam is introduced into an optical disk drive, commercial optical disks with a track size between the CD track pitch and the DVD track pitch can also be read by the alternative DVD laser beam. The issue that a typical optical disk drive cannot read the great variety of the optical disks of uneven track size can be solved.

Therefore, by applying this invention, the drawbacks of conventional optical disks, like limitation of applicable optical disks and reduced ration of reading optical disk in an optical disk drive, can be successfully overcome.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of selecting laser beam in an optical disk drive, wherein either CD laser beam or DVD laser beam is selected to read data from an optical disk, the method comprising the steps of:
using the CD laser beam to read the optical disk to generate a first tracking error signal;
determining if the first tracking error signal is correct; and
using the CD laser beam to read data from the optical disk if the first tracking error signal is correct; and using the DVD laser beam to read data from the optical disk if the first tracking error signal is incorrect.

2. The method according to claim 1, wherein the step of determining if the first tracking error signal is correct further comprises:
determining if the first tracking error signal is not smaller than a threshold;
using the CD laser beam to read data from the optical disk if the first tracking error signal is not smaller than the threshold; and using the DVD laser beam to read the optical disk and generate a second tracking error signal if the first tracking error signal is smaller than the threshold; and
using the DVD laser beam to read data from the optical disk if the second tracking error signal is correct, and ending the method if the second tracking error signal is incorrect.

3. A method of selecting laser beam in an optical disk drive, wherein either CD laser beam or DVD laser beam is selected to read data from an optical disk, the method comprising the steps of:
using the CD laser beam to illuminate the optical disk to obtain a memory capacity of the optical disk;
determining if the memory capacity is not larger than a standard memory capacity; and
using the CD laser beam to read data from the optical disk if the memory capacity is not larger than the standard capacity, and using the DVD laser beam to read data from the optical disk if the memory capacity is larger than the standard capacity.

4. The method according to claim 3, wherein after the step of determining if the memory capacity is not larger than the standard capacity, the method further comprises:
using the DVD laser beam to read the optical disk and generate a tracking error signal if the memory capacity is larger than the standard capacity;
determining if the tracking error signal is correct; and
using the DVD laser beam to read data from the optical disk if the tracking error signal is correct, and ending the method if the tracking error signal is incorrect.

5. A method of selecting laser beam in an optical disk drive, wherein either a first laser beam or a second laser beam is selected to read data from an optical disk, the method comprising the steps of:
using the first laser beam to read the optical disk to generate a first testing result;
determining if the first testing result is normal; and
using the first laser beam to read data from the optical disk if the first testing result is normal, and using the second laser beam to read data from the optical disk if the first testing result is abnormal.

6. The method according to claim 5, wherein the first testing result comprises a first tracking error signal.

7. The method according to claim 6, wherein the step of determining if the first testing result is normal further comprises: determining if the first tracking error signal is not smaller than a threshold.

8. The method according to claim 7, wherein the first laser beam is used to read data from the optical disk if the first tracking error signal is not smaller than the threshold, and the second laser beam is used to read data from the optical disk if the first tracking error signal is smaller than the threshold.

9. The method according to claim 5, wherein the first testing result comprises a memory capacity of the optical disk.

10. The method according to claim 9, wherein the step of determining if the first testing result is normal further comprises: determining if the memory capacity is not larger than a standard memory capacity.

11. The method according to claim 10, wherein the first laser beam is used to read data from the optical disk if the memory capacity is not larger than the standard capacity.

12. The method according to claim 10, wherein the second laser beam is used to read data from the optical disk if the memory capacity is larger than the standard capacity.

13. The method according to claim 5, wherein the step of using the second laser beam to read the optical disk, if the first testing result is abnormal, further comprises:
using the second laser beam to read the optical disk and generate a second tracking error signal;
determining if the second tracking error signal is correct; and
using the second laser beam to read data from the optical disk if the second tracking error signal is correct, and ending the method if the second tracking error signal is incorrect.

14. The method according to claim 5, wherein the wavelength of the second laser beam is smaller than the wavelength of the first laser beam.

15. The method according to claim 14, wherein the first laser beam is CD laser beam.

16. The method according to claim 14, wherein the second laser beam is DVD laser beam.

17. The method according to claim 5, wherein the wavelength of the second laser beam is larger than the wavelength of the first laser beam.

18. The method according to claim 17, wherein the first laser beam is DVD laser beam.

19. The method according to claim 17, wherein the second laser beam is CD laser beam.

20. The method according to claim 5, wherein the optical disk drive is capable of reading CD and DVD optical disks.
